(19) United States
(12) Patent Application Publication
(10) Pub. No.: US 2019/0045736 A1
(43) Pub. Date: Feb. 14, 2019

(54) Rotary Platforms

(71) Applicant: Waikato Milking Systems LP, Hamilton (NZ)

(72) Inventors: Joshua Wayne Janmaat, Morrinsville (NZ); Michael David Bates, Auckland (NZ)

(21) Appl. No.: 16/161,919

(22) Filed: Oct. 16, 2018

Related U.S. Application Data
(63) Continuation of application No. 14/536,767, filed on Nov. 10, 2014.
Application No. 14/536,767 is a continuation of application No. 13/127,332, filed on Jul. 19, 2011, now abandoned.

(30) Foreign Application Priority Data
Nov. 3, 2008 (NZ) 572534

(51) Int. Cl. A01J 5/003; A01J 99/00; A01K 1/12; A01J 7/00

(52) U.S. Cl. CPC A01J 5/003; Y10T 428/24777; A01J 99/00; A01J 7/00; A01K 1/126

(57) ABSTRACT

A rotary dairy cow milking platform that rotates about a rotational axis and has a plurality of pre-fabricated moulded bail floor defining modular components 1-10 and a supporting substructure 12, 13 14. Each modular component is detachable from the substructure and has been pre-formed independently of any components from the substructure. Each modular component is also totally or at least in part formed from a fibre reinforced resin based composite material. The modular components each have a mould defined rigid exoskeleton 34 wrapped about an inlay or an imbedded core 33 of another material moulded within the exoskeleton. The end peripheries of the modular components are substantially radially aligned with respect to the axis of rotation of the milking platform. Further, the modular components have been assembled onto the substructure to form a substantially annular deck of the milking platform.

### FILING HISTORY

This application is a continuation filing from application No. Ser. 14/536,767 filed on Nov. 10, 2014, which is a continuation filing from application No. Ser. 13/127,332 filed on Jul. 19, 2011, which is a national phase application from PCT/NZ2009/023511 filed on Nov. 3, 2009, each of which is herein incorporated by reference in its entirety.

### FIELD OF THE INVENTION

The present invention relates to milking platforms, components thereof, related facilities and uses.

### DESCRIPTION OF RELATED ART

Milking platforms of rotary milking facilities tend to be metal platforms or concrete topped metal platforms. They may run about a central pivot or be tracked, or both.

### SUMMARY OF THE INVENTION

The present invention recognises that speed of erection can be obtained by providing moulded components (particularly of a composite material) for use in the erection of the platform of a milking facility. This is particularly so where each moulded component, to form part of a substantially annular platform, defines a plural sequence of bail floors or parts thereof.

The present invention also, or in addition, sees an advantage from being able to provide componentry of a platform able to be assembled onto a sub-frame and/or to each other and/or so as to relate to each other as a substantially continuous annulus.

The present invention also, or in addition, sees an advantage in the use of light weight componentry able to be readily transported (eg, in a typical shipping container) yet able to be speedily assembled to provide a long service life rotary milking platform.

It is also in accordance with certain aspect of the present invention considered desirable to provide a “feel” providing surface for milking animals of a floor formed from modular components (for example of composite materials able to be moulded to a shape), the feel being provided by (1) attached and/or inlaid resilient material(s) and/or (2) fully or partly embedded filler or core material(s).

It is an object of the present invention to provide an alternative to the primarily steel and/or steel and concrete rotary milking platforms.

It is a further, or alternative, object of the present invention to provide a rotary milking platform, moulded modules (preferably involving composite material(s)) useful when assembled in defining a rotary milking platform (whether on a sub-frame or not), a milking facility having moulded floor defining components (preferably involving composite material(s)) and related methods and procedures. In an aspect the invention is a rotary milking platform having a bail floor, or at least part of its floor and/or sub-floor if matted, formed at least in part from a composit material.

Preferably the platform is at least in part of moulded components. Preferably each such moulded component is a module.

Preferably each module is totally or at least in part of the composite material.

Preferably the composite material is fibreglass or other fibre reinforced plastics and/or polymeric and/or resin based system.

Preferably the composite material(s) include, as an inlay or an imbedded core, another material (eg, a foam or filler).

Preferably each module is to define at least part of the floor and/or mat support for a plurality of bails.

Preferably each module is provided with an inner and outer curved or facetted periphery (preferably circular or a continuous curve) and/or preferably the end peripheries are substantially radially aligned with respect to the axis of rotation of the to be defined rotary milking platforms.

In another aspect the invention is a rotary milking platform having a rotatable sub-floor frame and an at least in part composite material floor or floor defining assembly carried thereby.

Preferably the platform is at least in part of moulded components.

Preferably each such moulded component is a module.

Preferably each module is totally or at least in part of the composite material. Preferably the composite material is fibreglass or other fibre reinforced plastics and/or polymeric and/or resin based system.

Preferably the composite material(s) include, as an inlay or an imbedded core, another material (eg, a foam or filler).

Preferably each module is to define at least part of the floor and/or mat support for a plurality of bails.

Preferably each module is provided with an inner and outer curved or facetted periphery (preferably circular or a continuous curve) and/or preferably the end peripheries are substantially radially aligned with respect to the axis of rotation of the to be defined rotary milking platforms.

In another aspect the invention is a milking facility that includes a walk-on/back-off entrance/exit arrangement to bails defined on a rotatable platform where the floor of the platform, optionally at least in part matted, is at least in part of a composite material.

Preferably the platform is at least in part of moulded components.

Preferably each such moulded component is a module.

Preferably each module is totally or at least in part of the composite material. Preferably the composite material is fibreglass or other fibre reinforced plastics and/or polymeric and/or resin based system.

Preferably the composite material(s) include, as an inlay or an imbedded core, another material (eg, a foam or filler).

Preferably each module is to define at least part of the floor and/or mat support for a plurality of bails.

Preferably each module is provided with an inner and outer curved or facetted periphery (preferably circular or a continuous curve) and/or preferably the end peripheries are substantially radially aligned with respect to the axis of rotation of the to be defined rotary milking platforms.

In another aspect the invention is a rotary milking platform having a rotatable sub-floor frame and a composite material including floor carried thereby at least in part matted with a resilient material.

Preferably the platform is of moulded components.

Preferably each such moulded component is a module.

Preferably each module is totally or at least in part of the composite material.

Preferably the composite material is fibreglass or other fibre reinforced plastics and/or polymeric and/or resin based system.

Preferably the composite material(s) include as an inlay or an imbedded core another material (eg, a foam or filler).

Preferably each module is to define at least part of the floor and/or mat support for a plurality of bails.

Preferably each module is provided with an inner and outer curved or facetted periphery (preferably circular or a continuous curve) and/or preferably the end peripheries are substantially radially aligned with respect to the axis of rotation of the to be defined rotary milking platforms.

In another aspect of the invention is a milking facility that includes a walk-on/back-off entrance/exit arrangement to bails defined on a rotatable platform at least where the floor of the platform is at least in part of a composite material (optionally cored by another material), or is an assemblage of mouldings at least in part of a composite material (optionally cored by another material), each bail being matted by one or more resilient inlay.

Preferably the platform is of moulded components.

Preferably each such moulded component is a module.

Preferably each module is totally or at least in part of the composite material.

Preferably the composite material is fibreglass or other fibre reinforced plastics and/or polymeric and/or resin based system.

Preferably the composite material(s) include as an inlay or an imbedded core another material (eg, a foam or filler).

Preferably each module is to define at least part of the floor and/or mat support for a plurality of bails.

Preferably each module is provided with an inner and outer curved or facetted periphery (preferably circular or a continuous curve) and/or preferably the end peripheries are substantially radially aligned with respect to the axis of rotation of the to be defined rotary milking platforms.

In still another aspect the invention is a moulded module able to be associated with others on a rotatable support to define a rotary milking platform, the module being moulded at least in part in a composite material.

Preferably the composite material(s) include as an inlay or an imbedded core another material (eg, a foam or filler).

Preferably each module is to define at least part of the floor and/or mat support for a plurality of bails.

Preferably each module is provided with an inner and outer curved or facetted periphery (preferably circular or a continuous curve) and/or preferably the end peripheries are substantially radially aligned with respect to the axis of rotation of the to be defined rotary milking platforms.

In another aspect the invention is a moulded module able to be associated with others on a rotatable support to define a rotary milking platform, the module being moulded at least in part in a composite material and including one or more resilient material mats.

Preferably the composite material(s) include as an inlay or an imbedded core another material (eg, a foam or filler).

Preferably each module is to define at least part of the floor and/or mat support for a plurality of bails.

Preferably each module is provided with an inner and outer curved or facetted periphery (preferably circular or a continuous curve) and/or preferably the end peripheries are substantially radially aligned with respect to the axis of rotation of the to be defined rotary milking platforms.

In another aspect the invention consists in a module for use as part of a milking platform, a rotary milking platform having such a module and/or a milking facility having such a platform with such modules; wherein each module defining one or more bail floor area (whether post mould matted, or not, or whether in mould matted, or not) has been manufactured in a mould by resin infusion about a filling material (eg, a foam plastics material) about at least part of which there has been positioned in mould the fibres to be embedded in the resin.

Preferably each module defines part of an annulus having plural bail floors defined.

Preferably the resin infusion defines a depressed region to be post mould matted.

Preferably the mouldings have any one or more of the characteristics herein described with or without reference to any one or more of the accompanying drawings.

In another aspect the invention is a rotary milking platform having an annular platform floor (each bail being or to be optionally matted fully or in part) defined by an assembly of moulded floor defining components of composite material, each defining part of, or all of, one or more bail floors.

In another aspect the invention is a rotary milking platform having an annular platform floor (optionally each bail being or to be optionally matted fully or in part) defined by an assembly of moulded floor defining components, each defining part of, or all of, one or more bail floors.

Preferably each component is resin infusion moulded about at least one filler or core to provide an exoskeleton of a composite material.

In still another aspect the invention is a rotary milking platform having an annular platform floor, each bail being or to be matted fully or in part, the floor or sub floor being defined by an assembly of moulded floor defining components, each defining part of, or all of, one or more bail floors.

Preferably each moulded component is at least in part (and preferably wholly) provided with a composite material surround (eg, as if an exoskeletal surface providing surround about a filler or core providing material). Most preferably the moulding is by a process of infusion moulding with a composite system (eg, a resin system without fibre or a resin system including fibre) into cavities about one or more filler or core providing material (eg, a foam, a blow moulded foam, an expanded form or the like), optionally, but preferably, in conjunction with in mould position fibres resulting in the moulding that is at least in part of composite material(s).

In another aspect the invention is a rotary milking platform having a plurality of supported composite material mouldings defining at least substantially an annular floor supported by a rotatable substrate.

Preferably each moulded component is at least in part (and preferably wholly) provided with a composite material surround (eg, as if an exoskeletal surface providing surround about a filler or core providing material).

Most preferably the moulding is by a process of infusion moulding with a composite system (eg, a resin system without fibre or a resin system including fibre) into cavities about one or more filler or core providing material (eg, a foam, a blow moulded foam, an expanded form or the like), optionally, but preferably, in conjunction with in mould position fibres resulting in the moulding that is at least in part of composite material(s).

In another aspect the invention is a rotary milking platform having an annular platform floor defined by an assembly of moulded floor defining components, each defining part of, or all of, one or more bail floors, each bail being matted with a resilient material.

Preferably each moulded component is at least in part (and preferably wholly) provided with a composite material surround (eg, as if an exoskeletal surface providing surround about a filler or core providing material). Most preferably the moulding is by a process of infusion moulding with a composite system (eg, a resin system without fibre or a resin system including fibre) into cavities about one or more filler or core providing material (eg, a foam, a blow moulded foam, an expanded form or the like), optionally, but preferably, in conjunction with in mould position fibres resulting in the moulding that is at least in part of composite material(s).

In another aspect the invention is a rotary milking platform having an annular platform floor (matted fully or in part) defined by an assembly or juxtapositioning of moulded floor defining components, each defining part of, or all of, one or more bail floors, each bail being matted by one or more resilient matting inlay.

Preferably each moulded component is at least in part (and preferably wholly) provided with a composite material surround (eg, as if an exoskeletal surface providing surround about a filler or core providing material). Most preferably the moulding is by a process of infusion moulding with a composite system (eg, a resin system without fibre or a resin system including fibre) into cavities about one or more filler or core providing material (eg, a foam, a blow moulded foam, an expanded form or the like), optionally, but preferably, in conjunction with in mould position fibres resulting in the moulding that is at least in part of composite material(s).

In another aspect the invention is a rotary milking platform having an annular platform floor (optionally matted fully or in part) defined by an assembly of moulded floor defining components, each defining part of, or all of, one or more bail floors, the bail floors being radially aligned.

Preferably each moulded component is at least in part (and preferably wholly) provided with a composite material surround (eg, as if an exoskeletal surface providing surround about a filler or core providing material). Most preferably the moulding is by a process of infusion moulding with a composite system (eg, a resin system without fibre or a resin system including fibre) into cavities about one or more filler or core providing material (eg, a foam, a blow moulded foam, an expanded form or the like), optionally, but preferably, in conjunction with in mould position fibres resulting in the moulding that is at least in part of composite material(s).

In still another aspect the invention is a rotary milking platform having an annular platform floor (each bail being or to be optionally matted fully or in part) defined by an assembly, or on a rotary sub-frame in juxtaposition of moulded floor defining components, each component defining part of, or all of, a plurality of adjacent bail floors.

Preferably each moulded component is at least in part (and preferably wholly) provided with a composite material surround (eg, as if an exoskeletal surface providing surround about a filler or core providing material). Most preferably the moulding is by a process of infusion moulding with a composite system (eg, a resin system without fibre or a resin system including fibre) into cavities about one or more filler or core providing material (eg, a foam, a blow moulded foam, an expanded form or the like), optionally, but preferably, in conjunction with in mould position fibres resulting in the moulding that is at least in part of composite material(s).

In still another aspect the invention is a milking facility that includes a walk-on/back-off entrance/exit arrangement to bails defined on a rotatable platform where the floor of the platform (optionally matted at least in part by different material) is moulded components in assembly or juxtaposition, whether on a rotatable sub-frame or not.

Preferably each moulded component is at least in part (and preferably wholly) provided with a composite material surround (eg, as if an exoskeletal surface providing surround about a filler or core providing material). Most preferably the moulding is by a process of infusion moulding with a composite system (eg, a resin system without fibre or a resin system including fibre) into cavities about one or more filler or core providing material (eg, a foam, a blow moulded foam, an expanded form or the like), optionally, but preferably, in conjunction with in mould position fibres resulting in the moulding that is at least in part of composite material(s).

In still another aspect the invention is a rotary milking platform having a plurality of supported mouldings defining at least substantially an annular floor supported by a rotatable substrate; wherein inwardly and/or outwardly there is a fringe not involving said mouldings (but which nonetheless may be an assembly or juxtapositioning of mouldings); and wherein (A) (i) the, or any, inward fringe covers plant and/or (ii) provides a walkway and/or (B) the, or any, outward fringe provides splash protection.

In another aspect the invention is a moulded module able to be associated with others on a rotatable support to define a rotary milking platform, the module including for its, or each, bail floor it is to fully or in part define, a leg spreading profile (integrally defined or subsequently added).

In another aspect the invention is a moulded module able to be associated with others on a rotatable support to define a rotary milking platform, the module including for its, or each, bail floor it is to fully or in part define, an udder spray site or sites.

In another aspect the invention is a rotary milking facility having a rotary platform with prefabricated or moulded profiled floor segments, each segment or most segments providing multiple substantially radially aligned stall floors, and at least one zone for entering onto an aligned stall and at least one zone for exiting from an aligned stall.

In another aspect the present invention consists in, in combination, moulded modules or modules as previously defined, optionally with or without any member or members of a support therefore.

Preferably said combination is part of a kit.

In a further aspect the invention consists in modules, individual bails, a rotary platform, a milking facility, and related methods of assembly and use, substantially as herein described with or without reference to any one or more of the accompanying drawings.

As used here in the term “composite material” or variations of it to a matrix or binder that binds together a reinforcement material or materials refers to materials typified by fibreglass but not restricted solely to fibreglass which incorporate reinforcement fibre (whether as a mat or otherwise) imbedded in a surrounding matrix such as a suitable settable resin and/or polymeric material. Fibre reinforcement can be by way of long or short fibre lengths of glass fibre, plastics material fibre (eg, KEVLAR™), arbon fibre, or the like. The sheets or mats can be chopped strand mats (CSM) or a woven fabric. Owens Corning FIBERGLAS™ sheets can be used.

Multiple mat types can be used in different layers. Preferably KEVLAR™ armours the structure under a gelcoat protected surface of the infusion moulding.

Preferably the composite material(s) is moulded preferably using a resin infusion moulding process. This involves a flowable atrix or binder being infused into the mould after fibre placement therein and/or after any other embeddable material or forms is placed therein (eg, as a filler or core).

In other forms, however, the moulding can involve a one part mould to provide the upper surface of the moulded item into which, or onto which, resin and/or polymeric matrix can be laid up in order to assume the shaped surface whilst embedding the in mould placed fibres, the underlying shape and its final finish being less important.

As used herein “resin” relates to any settable liquid or flowable matrix. Preferably it is a polymeric system.

The resin system preferably is a thermosetting unsaturated polyester system, a vinylester system or an epoxy system. Particularly preferred are a vinylester-epoxy profusion resins.

Gelcoats (e.g. as used in New Zealand marine or swimming pool applications) can be applied to exposed surfaces. The resultant thickness of the floor is to withstand prolonged use and preferably is at least several millimetres thick with ample reinforcement embodied in the binding resin system to ensure the fibres take up all the expected tensile loads.

As used herein reference to “foamed or expanded plastics material” or “foamed or expanded polymeric material” preferably includes within its ambit any compatible singular or mix of materials that collectively provide a filler about which and at least in part into which the resin or other polymeric material can be infused to bind the reinforcing fibres suitable organic foam materials include those of polystyrene, polyurethane, polyisocyanurate and urea-formaldehyde. Other options are bound.

Preferably any foamed plastic or other material is preferably substantially rigid so as to provide little in the way of flexing under the exoskeletal moulded material eg, fibreglass. Of course other fillers including wood, or even flexible plastics materials (foamed or otherwise) can be used as the core or filling material.

Reference to a “mat or matted” surface or variation of it in conjunction with the moulded component preferably relates to a fitted, affixed and/or inlayed mat of, for example, a resilient synthetic or natural rubber (or other elastomeric material), optionally reinforced, typified, by way of example, by fibre or metal reinforced rubber belting material as used in conveyors. There is however less of an issue with the material needing to take tensile forces than is the case with a conveyor belt type material. Nevertheless the dairy usage as a mat to provide comfort for and reduce the noise by dairy cows on the platform does mean that preferably a strong material requiring infrequent replacement is utilised. Such a material as a mat protects the moulded surface that underlies the mat and which is not normally contacted by the animal's hooves.

As used herein to “bail” or “stall” should be considered as being interchangeable.

Sometimes their usage refers to the area of floor required by an animal and in other uses or, as the context allows, relates to the (preferably separated) individual milking positions of the platform. The term “bail” or “stall” preferably does not include that area inwardly of where the animal is to stand, head inwards, which may be provided as a walkway to allow access about the platform to each animals head.

Reference herein to “ramps” or the like to allow ingress and/or egress from the platform does not necessarily require any inclination of the walkway. Nor does it require that the walkways be separate or singular. In some embodiments, there may be zones of bails or stalls each having their own entrance way and each having their own egress way.

It is preferred in accordance with the present invention that the animals walk head first into their bail or stall and exit by backing off the platform or at least out of the bail or stall area where they are milked to exit from the platform.

As used herein “annular”, “annulus” or variations of it include a shape, when viewed in plan, that may or may not have an inner periphery or an outer periphery as a smooth curve. Whilst both are preferably substantially circular, facetted options are included.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

### DRAWINGS

The entire disclosures of all applications, patents and publications, cited above and below, if any, are hereby incorporated by reference.

Preferred forms of the present invention will now be described with reference to the accompanying drawings in which:

FIG. 1 is a plan view of a annular milking platform made up by nine prefabricated and/or moulded components (for example each to define 6 bail areas) to provide, by way of example, a 54 bail annular platform,

FIG. 2 is a sectional view looking transverse of the radial support preferred I Beam of a platform as in FIG. 1,

FIG. 3 is a radial view of a section of a platform as in FIGS. 1 and 2, the I Beams being shown end on or in section and showing over the left hand I Beam a mating to the sub-frame structure of adjacent moulded omponents,

FIG. 4 is a view in a similar direction to that of FIG. 2 but rather than showing a section of the mouldings mid bail, instead showing the platform assembly at a point where a through platform port is shown and post members are supported directly or indirectly from the radial rib,

FIG. 5 shows a plan view of the radial rib of an arrangement as in FIG. 4 showing plates fitted thereto which allows fitment of the moulded and other components thereto, and

FIG. 6 is a view in elevational section of a facility showing an exterior ramp to the platform or from the platform for entrance and exiting of animals and showing the relationship of the platform to a roof support.

### DETAILED DESCRIPTION

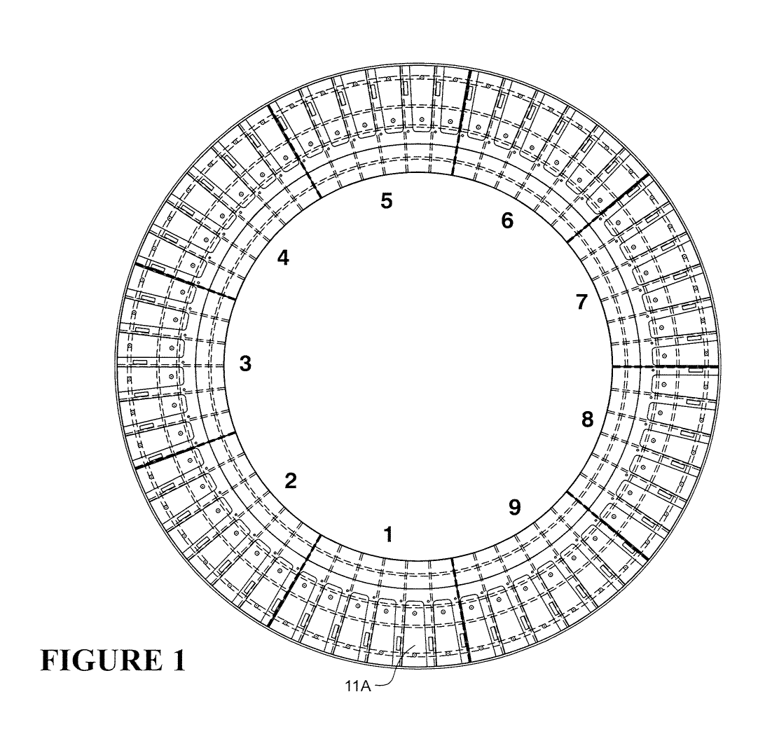

FIG. 1 shows in plan an annular milking platform of 54 bails made up of modules 1 to 9 in series about the annulus. Each of the modules 1 through 9 defines 6 bails.

Other relationships between moulded modular components are nonetheless envisaged as typical examples can range from, say, 20 to 80 bails without necessarily being restricted thereto. Typical examples include as few as 26 bails. Other examples include and are not limited to 50, 54, 60, etc.

For some sizes there may be a desirability to provide two or more types of module that complement to the resulting annulus or substantially annular platform shape.

A preferred module 1 through 9 is preferably formed by resin (e.g. vinylester-epoxy ex-Nuplex) infused moulding (eg, fibreglass) that provides an exoskeleton and structural form about an expanded plastics foam form (or forms) previously placed in mould between glass fibre ravings, mats, textile, etc (e.g. multiple layers of matting such as of Kevlar (ARRAMAT™), and double bias and/or biaxial glassfibre mats (e.g. Owens Corning, Dongil, or others)).

Any suitable surface coating geticoat (e.g. Nuplex) can be used. It is envisaged that whilst each module to be used as a module of the annulus can be in totality a composite material such as fibreglass there is an advantage when moulding such a material, particularly when using resin infusing techniques, to preload the tooling with not only the fibre reinforcement materials for the exoskeletal areas but to lay that about a filler or core material that not only reduces the resin quantities required to infuse about the fibres but also keeps the fibres appropriately positioned for the infusion process. Suitable fillers can be any suitable material rigid or flexible. A core or filler can be of one or more parts most preferably however it is a foam plastics material such as for example foamed polyurethane or foamed polystyrene.

The use of an appropriate choice as the filler or core reduces the weight of the overall moulding. A high density polyurethane foam is preferred. Preferably as a consequence of the use of a filler or core each bail floor area is preferably underlaid by such a core of material and has by way of example fibreglass above and below of sufficient thickness and strength not withstanding a preferred provision of a depression or placement of a rubber or elastomeric mat for the animals to stand on.

Preferably shapes vary but the platform may be substantially as shown in the attached drawings.

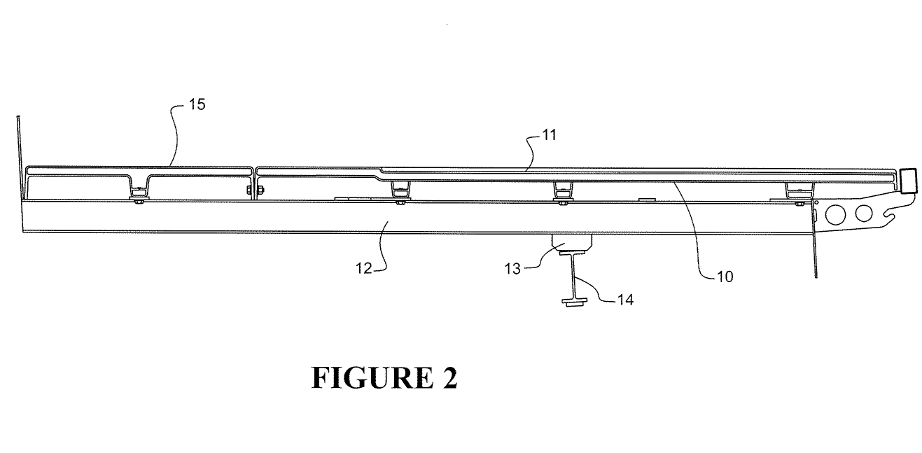

FIG. 2 shows, for a typical annulus, the moulded component 10 with an upper recess into which a matting material, for example reinforced natural or synthetic rubber, can be inserted. Such an arrangement is shown as 11A in FIG. 1. Whilst it can be in mould affixed, preferably to allow ease of replacement it is affixed post moulding.

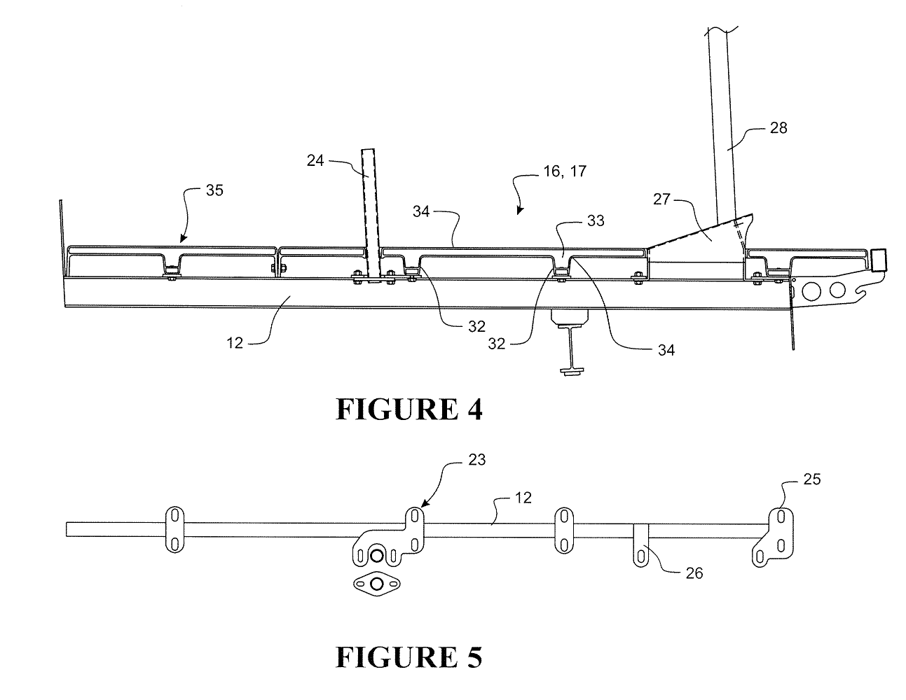

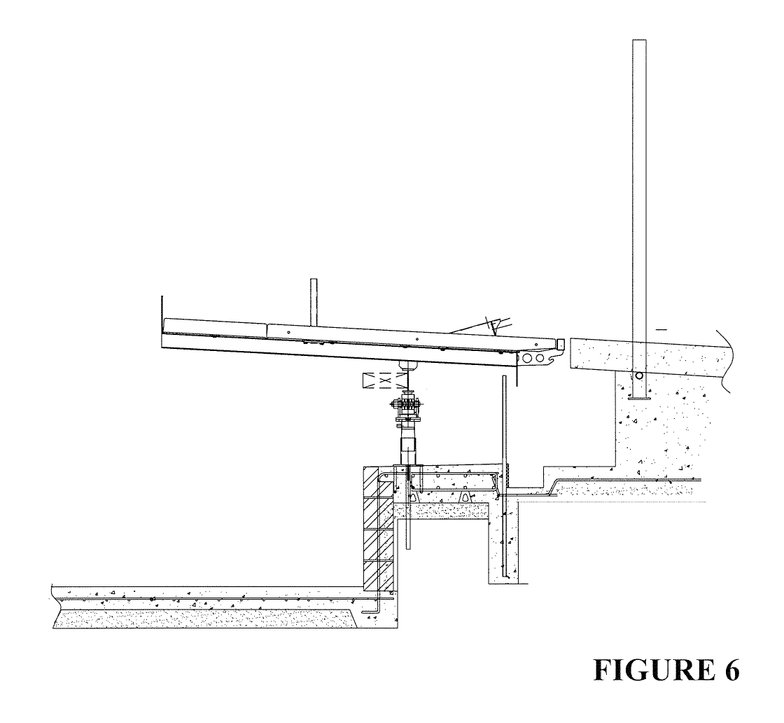

As shown in the drawings, preferably each module 16 or 17 is provided with downwardly moulded ribs with mould provided receivers for set screws to allow attachment to the substructure eg, via flanges or brackets. These downwardly directed ribs which may include female threaded members therein as shown as 32 in FIG. 4.

The filler of foam plastics material is preferably that region of each module shown as 33 whilst the fiberglass is 34.

A person skilled in the art will appreciate how similar techniques can be used for the walkway providing modules 35. These modules 35 are preferably not used to extend the length of the milking position but rather to allow access to the head of the cow when in the milking condition.

Referring to FIG. 2, a radial steel or alloy rib 12 of the sub-frame structure is preferably able to run with roller 13 on an annular rail 14 and be confined to be supported thereby in a manner typical of the platforms of Waikato Milking Systems of Hamilton, New Zealand, as shown on their website www.waikatomilking.co.nz or as discussed in New Zealand patent specification NZ 551609 granted to Rotary Platforms NZ Limited, or with pinch rollers.

Shown inwardly of the moulded member 10 is a further moulded member 15 which can be used as an internal walkway, if desired, beyond the bail floor for milking.

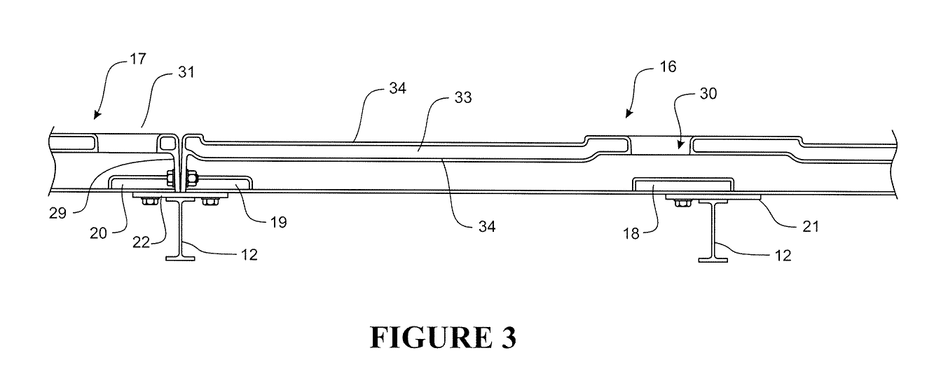

FIG. 3 shows the radial ribs 12, a first module 16 and a second proximate module 17 fitted to be supported by such a sub-frame. Shown are alloy blocks 18, 19 and 20 imbedded in the composite mouldings so as to allow fixing by bolting to flanges 21 and 22 respectively. Examples of such flanges are shown in FIG. 5 with some flanges (eg, 23) being adapted to accommodate fitment of posts 24 whilst others, (eg, 25 and 26) being adapted to allow the bolting of an access port providing fitting 27 for a post 28. Such affording 27 serves much the same purpose as disclosed in aforementioned patent specification 551609 granted to Rotary Platforms Limited.

As can be seen in the drawings each module can have a downwardly directed flange 29 to allow bolting to a like flange of the adjacent module.

Provision can be made, for example, at 30 and 31 for post and/or post footing/port fitment.

1. A rotary dairy cow milking platform which rotates about a rotational axis, said platform comprising a plurality of pre-fabricated moulded bail floor defining modular components and a supporting substructure, wherein the modular components are detachable from the substructure and each has been:
a) pre-formed independently of any components comprising or depending from the substructure, and
b) totally or at least in part formed from a fibre reinforced resin based composite material,
wherein each of said modular components has a mould defined rigid exoskeleton wrapped about an inlay or an imbedded core of another material moulded within the exoskeleton, each of said modular components having end peripheries substantially radially aligned with respect to the axis of rotation of the milking platform, the modular components having been assembled onto the substructure to form a substantially annular deck of the milking platform, and wherein:
the composite material comprises fibreglass or other fibre reinforced plastics, or a polymeric system; and
d) each modular component provides at least part of a floor for a plurality of cow milking bails.

2. The platform of claim 1, wherein each modular component has an inner and outer curved or facetted periphery.

3. The platform of claim 1, wherein the inlay or imbedded core comprises expanded foam and this has been placed in mould between glass fibre.

4. The platform of claim 3, wherein the glass fibre is in mat form.

5. The platform of claim 1, wherein each modular component has an upper surface recess into which a resilient matting material has been inserted.

6. The platform of claim 1, comprising inwardly and/or outwardly, a fringe not involving said modular components, but which nonetheless comprises an assembly or juxtapositioning of mouldings, wherein:
(A) (i) the, or any, inward fringe covers plant and/or (ii) provides a walkway and/or
(B) the, or any, outward fringe provides splash protection.

7. The platform of claim 1, wherein each of the modular components comprises multiple bails.

8. The platform of claim 1, wherein:
a) each modular component has been formed by resin infused moulding;
b) each modular component comprises a downwardly directed moulded rib;
c) each modular component has an inner and outer curved or facetted periphery;
d) the inlay or imbedded core comprises expanded plastics foam;
e) the inlay or embedded core is between glass fibre mat;
f) each modular component has a downwardly directed flange bolted to a like flange of an adjacent one of the modular components; and
g) the substructure comprises a radial steel or alloy rib that runs on a roller on an annular rail.

9. The platform of claim 8, wherein each modular component has an upper surface recess into which a resilient matting material has been inserted.

10. The platform of claim 8, wherein the downwardly directed rib includes a mould provided set screw receiver that provides for attachment of the modular component to the substructure.

11. The platform of claim 8, wherein the inlay or imbedded core comprises polyurethane foam and such foam is between fibreglass mat.
